(19) United States
(12) Patent Application Publication
(10) Pub. No.: US 2012/0112012 A1
(43) Pub. Date: May 10, 2012

(54) Decorative Arrangement Holder

(76) Inventor: Melissa Jackson, Carol Stream, IL (US)

(21) Appl. No.: 12/972,114

(22) Filed: Dec. 17, 2010

Related U.S. Application Data
(60) Provisional application No. 61/410,788, filed on Nov. 5, 2010.

(51) Int. Cl. A47G 7/02; F16M 11/22

(52) U.S. Cl. 248/27.8; 248/176.1

(57) ABSTRACT

The invention provides a stand for holding decorative elements that includes a first and a second sleeve. The first sleeve has an outer ring and an inner ring. The first sleeve is adapted to receive a first group of essentially longitudinal decorative elements that are passed between the first sleeve outer ring and the first sleeve inner ring. The second sleeve also has an outer ring and an inner ring. The second sleeve is also adapted to receive a second, different, group of essentially longitudinal decorative elements that are passed between the second sleeve outer ring and the second sleeve inner ring. At least a portion of the first group of essentially longitudinal decorative elements overlaps at least a portion of the second group of essentially longitudinal decorative elements.

### REFERENCE TO RELATED APPLICATION

This application claims the benefit of U.S. Provisional Patent Application No. 61/410,788, filed Nov. 5, 2010, the complete disclosure of which is incorporated herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files and records, but otherwise reserves all other rights.

### BACKGROUND OF THE INVENTION

1. Field of the Invention

This invention relates to the field of bouquet holders and specifically describes a device for holding an arrangement of flowers, foliage, branches, and other sculptural or decorative items.

2. Description of Related Art

Both professionals in the flower bouquet industry and consumers wanting to decorate the home face several challenges with respect to the stands or holders that are used to support flower or other decorative bouquets. Bouquet holders must be extremely flexible in what display items they can accommodate, as the potential items that may be used in a bouquet range from conventional flowers and foliage, having varying shapes and sizes and the need to be watered, to sculptural decorative items that may incorporate lighting effects with powering needs. Holders must be easily manufactured at low cost and be neither bulky nor heavy so as to be easily shipped. Holders must be sufficiently stable so as to maintain the display in an upright position in an environment subject to jostling or bumping.

Most importantly, the holder must be unobtrusive so as not to detract attention from the display and should provide the arranger with multiple options for artistic configuration. Optimally, a holder should provide the arranger with a means to remedy common problems associated with preparation of a display. One such problem is that display items, such as long stemmed flowers, tend to have a disproportionate amount of foliage on their top half and less on their bottom half, leading to a display that can appear sparse and unbalanced at the bottom.

U.S. Pat. No. 1,545,986, issued to Stollery et al. on Jul. 14, 1925, discloses a basket bouquet in which the stems of cut flowers are intermingled among moistened evergreen sprigs, the effect of which, among other claimed benefits, is an improved artistic look with respect to the lower portion of the bouquet. Although the Stollery disclosure addresses the issue of balancing the lower portion of the display, the holder itself is merely a conventional basket.

U.S. Pat. No. 1,890,405, issued to Cheesewright on Dec. 22, 1927, discloses a flower holder having a molded metal base capable of containing water and multiple supporting wires extending vertically upward, each with one or more flower support loops extending horizontally out at various heights. While Cheesewright addresses the need for the holder to be stable and provide support for the flowers, it does not allow the flower arranger significant flexibility in arrangement and is neither light nor non-bulky.

U.S. Pat. No. 2,003,101, issued to Asman on May 28, 1935, discloses a flower holder having a suction cup as its base out of which a serpentine wire forms successively larger double spirals having indentations where flower stems may rest. When placed in this holder, flowers form a “V” pattern. Similarly, U.S. Pat. No. 5,244,700, issued to Banschick on Sep. 14, 1993, discloses a simulated floral bouquet. In Banschick, the holder is a rack, of transparent material, having a base, with a center post and multiple tiers, one above the other and each having a greater diameter than the one below. Each tier is a plate having holes through which the decorative elements may pass. In place of flowers, the disclosure describes candy filled transparent tubes topped by decorative tufts. As with Asman, the display elements are arranged in a “V” pattern.

U.S. Pat. No. 4,224,763, issued to Prindle on Sep. 30, 1980, discloses a very simple horticultural arrangement holder that utilizes a tripod configuration. The items to be displayed are bound together by placing a ring around the upper portion of the stems, inclining them relative to one another so that the stems diverge from each other in directions leading away from the ring, and inserting the lower ends of the stems in a vessel which prevents the splaying of their lower ends. The result is a “teepee” like configuration with the flowers hanging out of the top. Prindle does not address the problem of sparse foliage in the lower portion of the display. Likewise, Prindle's disclosure lacks stability as it relies on the strength of a few stems for structural support.

U.S. Pat. No. 5,477,637, issued to Aldrich on Dec. 26, 1995, discloses a separator device used in conjunction with a tying device. Using a configuration that is essentially the opposite of that disclosed in Prindle, Aldrich discloses a separator ring having an inner and outer ring and angled channels through which the stems of flowers are passed and the use of a tying device that holds the stems of the flowers together at a point below the separator. The Aldrich device results in a “V” shaped arrangement and is intended for a hand-held bouquet in which the bottom portion of the stems with the separator are covered by wrapping.

Although there have been multiple and diverse approaches to the design of bouquet holders, it is apparent from the foregoing that none have met the need for a lightweight, non-bulky and relatively inexpensive holder whose design is unobtrusive, yet provides strong and stable support, while simultaneously providing the arranger with a variety of design options and allowing the arranger to address specific problems with such displays such as the balancing of fullness on the top and bottom of an arrangement.

### SUMMARY OF THE INVENTION

This invention provides a stand for holding decorative elements having a first sleeve and a second sleeve. The first sleeve has an outer ring and an inner ring. The first sleeve is adapted to receive a first group of essentially longitudinal decorative elements that are passed between the first sleeve outer ring and the first sleeve inner ring. The second sleeve also has an outer ring and an inner ring. The second sleeve is also adapted to receive a second, different group of essentially longitudinal decorative elements that are passed between the second sleeve outer ring and the second sleeve inner ring. At least a portion of the first group of essentially longitudinal decorative elements overlaps at least a portion of the second group of essentially longitudinal decorative elements.

In various alternative embodiments, the outer ring of the first sleeve may have a diameter greater than that of the outer ring of the second sleeve. There may be a third ring of a diameter greater than that of the inner ring of the second sleeve and displaced from the second sleeve along an axis passing longitudinally through the center of the second sleeve. There may be a fourth ring having an outer diameter greater than the second sleeve inner ring, but less than the third ring and positioned between the two, along an axis passing longitudinally through each. The third ring may be positioned relative to the second sleeve by at least one support member; and the third ring may be positioned to receive the second group of decorative elements along its outer diameter; or the third ring may be positioned to receive both the first and the second group of decorative elements along its outer diameter.

Where the third ring is positioned to receive both the first and second group of decorative elements, the two groups may overlap. Alternatively, this overlap may create a perception of enhanced density of the decorative elements along the overlap and the enhanced density may conceal a portion of the stand. In another embodiment, there may be a cap covering the end of second group of decorative elements that is nearest the second sleeve. And in still another embodiment, the decorative elements may be selected from a group consisting of flowers, branches, faux flowers and faux branches.

The invention also contemplates a stand for holding decorative elements having a first securing member, a second securing member and a spreading member. The first securing member is capable of securing a first plurality of essentially longitudinal decorative elements within a first diameter. The second securing member is capable of securing a second plurality of essentially longitudinal decorative elements within a second diameter. The spreading member is positioned apart from the first and second securing members and is further positioned to hold a portion of all of the decorative elements outside of a third diameter that is greater than both the first and second diameters.

In various alternative embodiments, the first diameter may be greater than the second diameter; the securing or spreading members may be essentially circular; the spreading member may be attached to the second securing member; or the first securing member may be affixed to the second securing member and the spreading member. In another embodiment, each of the securing members can hold the decorative elements outside of a fourth diameter that is less than the first and second diameters. In additional embodiments, at least a portion of the length of the first and second sets of decorative elements overlap. Where there is such an overlap, it may create an impression of enhanced density of the decorative elements. The enhanced density may also conceal a portion of the stand.

These and other features and advantages of this invention are described in, or are apparent from, the following detailed description of various exemplary embodiments of the apparatus according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein.

FIG. 1(a) shows a side view of the bottom dual ring-sleeve and attached frame of a first embodiment of the invention.

FIG. 1(b) shows a top-down view of the bottom dual ring-sleeve of a first embodiment of the invention having trimmed decorative branches held in place by the dual rings.

FIG. 1(c) shows a side view of the bottom dual ring-sleeve and attached frame of a first embodiment of the invention having decorative branches held in place by the dual rings against the frame.

FIG. 2(a) shows a top-down view of the top dual ring-sleeve of a first embodiment of the invention having decorative branches held in place by the dual rings.

FIG. 2(b) shows a side view of the top dual ring-sleeve of a first embodiment of the invention, having decorative branches held in place by the dual rings.

FIG. 3(a) depicts a cross-sectional view of a first embodiment of the invention.

FIG. 3(b) depicts the top and bottom portions of a first embodiment of the invention, separated, with both having decorative branches.

FIG. 3(c) depicts a first embodiment of the invention, fully assembled, with decorative branches.

FIG. 4(a) shows a side view of the bottom dual ring-sleeve and attached frame of a second embodiment of the invention having decorative branches held in place by the dual rings against the frame.

FIG. 4(b) show a perspective view of the bottom dual ring-sleeve and attached frame of a second embodiment of the invention having decorative branches held in place by the dual rings against the frame.

### DETAILED DESCRIPTION OF THE INVENTION

The present invention provides an apparatus for holding and displaying common decorative elements, such as branches, wherein a set of trimmed branch portions, similar to the lower half of the decorative elements, are affixed against a frame by a dual-ring sleeve and the decorative elements themselves are affixed separately in a ring by a second dual-ring sleeve of slightly larger diameter and draped over the frame, thereby producing a particularly stable, freestanding structure having an apparent fullness at the base with most of the structural elements of the holder hidden by the decorative elements.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

In this description, the term “decorative elements” is intended to be broadly construed and generally means any long and narrow decorative items that may be commonly displayed in an arrangement. This includes, but is not limited to, groupings of decorative materials from the natural world such as flowers and branches, decorative materials intended to imitate natural items such as silk or faux flowers and faux branches as well as decorative items unrelated to the natural world such as wire, plastic, glass or metallic sculptural constructs. A group of decorative elements need not be uniform among its members.

The term “ring,” as used herein, denotes an essentially circular shape, which would include ovals.

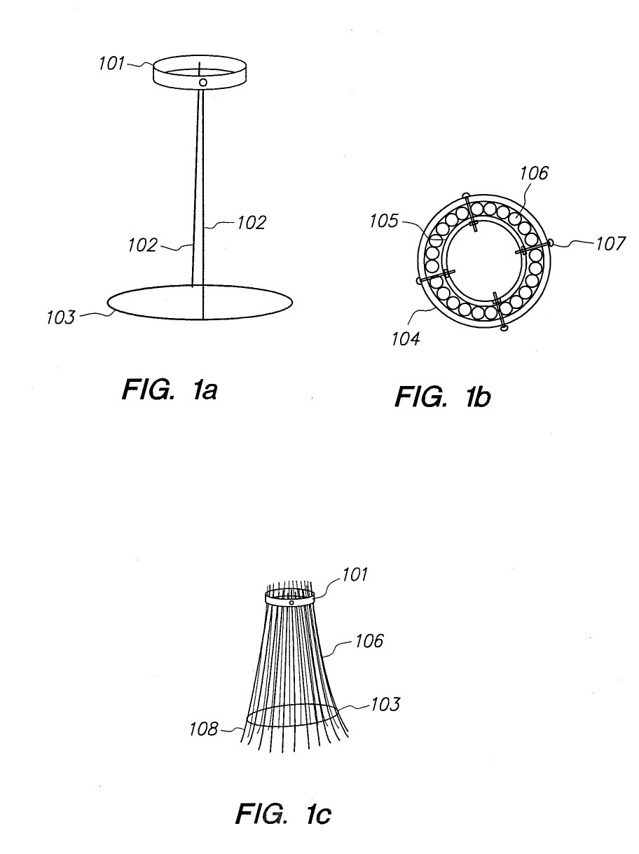

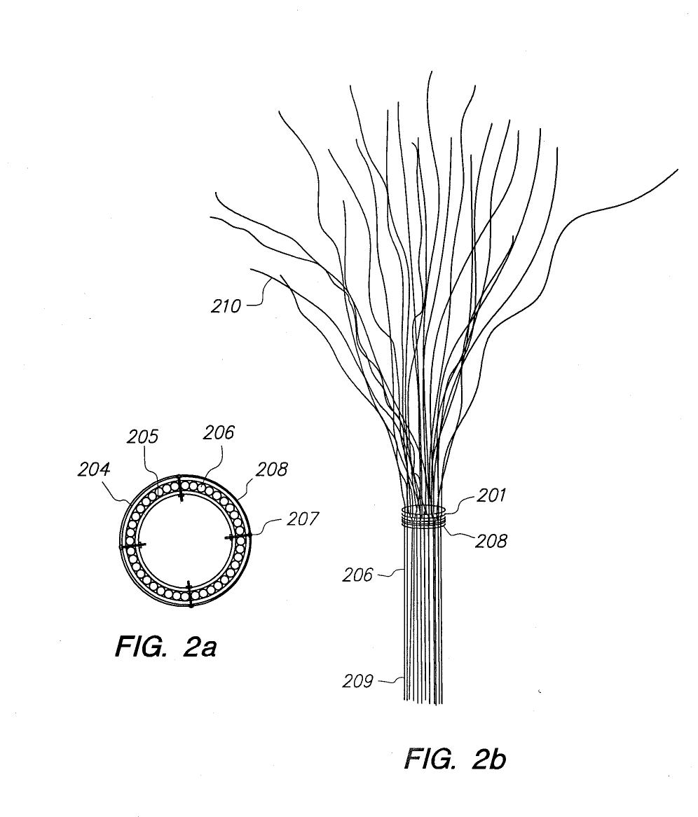

As shown in FIGS. 1(a) and 2(a), one embodiment of the invention consists of two parts. The first of these parts is shown in FIGS. 1(a), 1(b) and 1(c), and is comprised of a dual-ring sleeve 101, that consists of an exterior ring 104, an interior ring 105 and four bolts 107. Attached to the interior ring 105 of the dual-ring sleeve 101 are two support struts 102 that support a spreading ring 103. The interior ring 105 in this embodiment is about 2.75 inches in diameter and the exterior ring 104 is of a diameter that is sufficiently small so that the decorative elements 106, branches in this embodiment, are held securely. In this embodiment, the outer diameter of the exterior ring is about 3.5 inches. The spreading ring 103 is of a diameter that is larger than the dual-ring sleeve 101, about 4.385 inches in diameter, in this embodiment. The dual-ring sleeve 101, support struts 102 and spreading ring 103 in this embodiment are fabricated from metal, but other materials would also be appropriate.

FIG. 1(c) shows the apparatus of FIG. 1(a) in use. Decorative branch-portions 106, the top parts of which have been cut away, are placed between the exterior ring 104 and the interior ring 105. The bolts 107 are tightened so that the branch-portions 106 are held snugly against the interior ring 105 and the wire spreading ring 103.

As will be apparent from FIGS. 1(b) and 1(c), when in use, the branch-portions 106 extend a few inches below the position of the spreading ring 103 and the lower half of the branch-portions 108 are splayed outward, but simultaneously held in place against the spreading ring 103. The resulting cone-shaped structure creates a stable base for the display, while advantageously hiding the structural elements of the holder from view behind the branch-portions 106.

FIGS. 2(a) and 2(b) show the second part of one embodiment of the invention. This part is comprised of a second dual-ring sleeve 201 that consists of an exterior ring 204, an interior ring 205 and four bolts 207. The interior ring 205 in this embodiment is about 3.25 inches in diameter and the exterior ring 204 is of a diameter that is sufficiently small so that the branches 206, are held securely. In this embodiment, the outer diameter of the exterior ring is about 4 inches. Overall, the diameter of the second dual-ring sleeve 201 should be slightly larger than that of the dual ring-sleeve 101 of the first portion of the apparatus, but slightly smaller than that of the spreading ring 103. The vertical width of the dual-ring sleeve 201 will depend on the nature of the decorative elements 206. It must be of a width sufficient to hold the decorative elements securely. The vertical width may not, however, be so great that it prevents the lower ends of the decorative elements 209 from being splayed outward at least as far as the diameter of the spreading ring 103. In the embodiment of FIGS. 2(a) and 2(b), the vertical width of the dual-ring sleeve 201 is about 0.75 inches.

FIG. 2(b) shows the apparatus of FIG. 2(a) in use. Decorative branches 206 are placed between the exterior ring 204 and the interior ring 205. The bolts 207 are tightened so that the branch-portions 206 are held snugly against the interior ring 205. In this embodiment, the branches 206 are of a similar nature to the branch-portions 106, of FIG. 1(c), the latter being the same as the former, but having had approximately the upper half cut away. Since the exterior ring 204 will not otherwise be hidden from view, a decorative ribbon 208 or other wrapping may be added to conceal it.

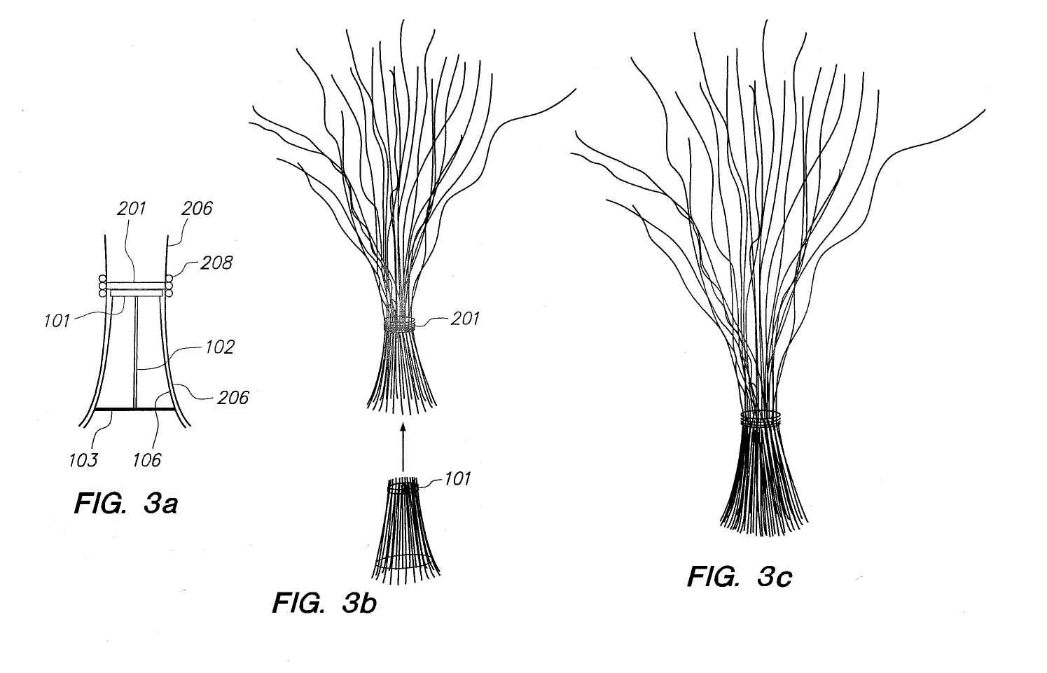

FIGS. 3(a), 3(b) and 3(c) show the two parts of this embodiment combined. As shown in FIG. 3(b), the dual-ring sleeve 201 with secured branches 206 of FIG. 2(b) slides over the top of dual-ring sleeve 101, spreading ring 103 and secured branch-portions 106 of FIG. 1(c). In this process, the bottom portion of the branches 209 are splayed out by the spreading ring 103 to the approximate diameter of the lower half of the branch-portions 108. The branch portions 106 and branches 206 are trimmed so that they end at relatively equal points in the final structure. FIG. 3(a) shows a cross-sectional view of the two parts of this embodiment in its final configuration. In this figure, the two dual-ring sleeves 101, 201 are nested, one atop the other, and a hollow cavity is formed within the bouquet. FIG. 3(c) shows this embodiment in its final configuration holding decorative elements.

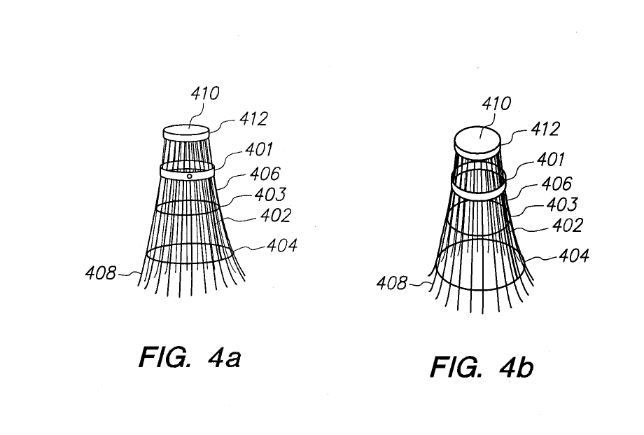

FIGS. 4(a) and 4(b) show a second embodiment of the invention that differs with respect to the configuration of bottom portion of the device. The bottom portion of the second embodiment is comprised of a dual-ring sleeve 401 that consists of an exterior ring, an interior ring and four bolts. Attached to the dual-ring sleeve 401 are two support struts 402, that support a first spreading ring 403 and second spreading ring 404. In addition, a cap 410 is placed over the upper ends of the decorative branch-portions 406, having a lip 412 that covers the top tips of those decorative branch-portions 406. As will be apparent from FIGS. 4(a) and 4(b), the lower half of the branch-portions 408 are splayed outward, but simultaneously held in place against the first and second spreading rings 403, 404. The two spreading rings are proportioned in diameter so that the branch-portions are held against both, forming a cone-shape.

In this second embodiment, the outer diameter of the dual-ring sleeve 401 is about 3.5 inches and its inner diameter is about 2.75 inches. The first spreading ring 403 is about 3.25 inches in diameter, while the second spreading ring 404 is about 4.385 inches in diameter. The first spreading ring 403 is positioned about 1.5 inches below the dual-ring sleeve 401, while the second spreading ring 404 is positioned about 4 inches below the dual-ring sleeve 401. This second embodiment of the lower portion of the invention is intended to be used with the upper portion shown in FIGS. 2(a) and 2(b) as shown in FIGS. 3(a), 3(b) and 3(c).

As will be apparent from the drawings, the structure of this apparatus has various inherent advantages over the holders of the prior art. First, the combination of the branch-portions 106 and the branches 206 provide a fullness to the arrangement and pleasing proportion that designs of the prior art lack. The resulting hourglass configuration, shown in FIG. 3(c), is likewise pleasing to the eye. Because the full branches 206 are placed over the top of the branch-portions 106 that are of a similar nature, this fullness is achieved with the illusion that no additional branch-portions have been added. Another advantage inherent in this configuration is that since the bottom of the branch-portions 108 and the bottoms of the branches 209 form the feet of the base, there is no base of the holder to get in the way of a water source. Therefore, water may be provided to the display using a very shallow bowl under the display. The holder is also extremely flexible in the vases that may be used with it and the arranger may easily remove the portion of the holder shown in FIG. 2(b) and place it in any type of conventional arrangement holder. The arrangement is exceptionally stable despite the fact that the holder is essentially hidden from view, except for a single ribbon, by the decorative elements. The holder, when fully assembled, also has a hollow space at its core that is concealed from view. This space may be put to various uses, such as a space to place a power source for lights used on the decorative elements. In the second embodiment, shown in FIGS. 4(a) and 4(b), the cap 410 may be utilized as a solid resting place for such a power source. Finally, the holder is fairly simple, comprising, in the first embodiment, two dual-ring sleeves and a spreading ring. Thus, it is cost-effective to manufacture and easily packaged and shipped.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A stand for holding decorative elements, said stand comprising:
a) a first sleeve having an outer ring and an inner ring, said first sleeve being adapted to receive a first group of essentially longitudinal decorative elements between said first sleeve outer ring and said first sleeve inner ring;
b) a second sleeve having an outer ring and an inner ring, said second sleeve being adapted to receive a second group of essentially longitudinal decorative elements, between said second sleeve outer ring and said second sleeve inner ring,
wherein at least a portion of said first group of essentially longitudinal decorative elements overlaps at least a portion of said second group of essentially longitudinal decorative elements.

2. The stand of claim 1 wherein said first sleeve outer ring has a diameter greater than that of said second sleeve outer ring

3. The stand of claim 1 wherein said second sleeve further comprises a third ring having an outer diameter greater than said second sleeve inner ring and displaced from said second sleeve along an axis passing longitudinally through the center of said second sleeve.

4. The stand of claim 3 wherein said second sleeve further comprises a fourth ring having an outer diameter greater than said second sleeve inner ring, but less than said third ring and positioned between said second sleeve and said third ring along an axis passing longitudinally through the centers of said second sleeve and said third ring.

5. The stand of claim 3 wherein said third ring is positioned relative to said second sleeve outer ring by at least one support member.

6. The stand of claim 3 wherein said third ring is positioned to receive said second group of decorative elements along its outer diameter.

7. The stand of claim 6 wherein said third ring is positioned to receive both said first and said second group of decorative elements along its outer diameter.

8. The stand of claim 1 wherein said overlap creates a perception of enhanced density of said decorative elements and conceals a portion of said stand in the region of said overlap.

9. The stand of claim 6 wherein said second group of essentially longitudinal decorative elements has a first end oriented near said second sleeve and a second end oriented near said third ring and a cap covering said first end.

10. The stand of claim 1 wherein said decorative elements are selected from the group consisting of flowers, branches, faux flowers and faux branches.

11. A stand for holding decorative elements, said stand comprising:
a) a first member for securing a first plurality of decorative elements within a first diameter;
b) a second member for securing a second plurality of decorative elements within a second diameter; and
c) a spreading member, positioned apart from said first and said second securing members so as to hold at least a portion of both said first and second pluralities of decorative elements outside of a third diameter,
wherein said third diameter is greater than both said first diameter and said second diameter.

12. The stand of claim 11 wherein said first diameter is greater than said second diameter.

13. The stand of claim 11 wherein said first and second securing members are essentially circular.

14. The stand of claim 11 wherein said spreading member is essentially circular.

15. The stand of claim 11 wherein said spreading member is affixed to said second securing member.

16. The stand of claim 15 wherein said first securing member is affixed to said spreading member and to said second securing member.

17. The stand of claim 11 wherein each of said first and second securing members is capable of holding said decorative elements outside of a fourth diameter that is less than said first and second diameters.

18. The stand of claim 11 wherein at least a portion of said first plurality of decorative elements overlaps with said second plurality of decorative elements.

19. The stand of claim 18 wherein said overlap creates an impression of enhanced density of said decorative elements in the region of said overlap.

20. The stand of claim 19 wherein said enhanced density conceals a portion of said stand.
